(19) United States
(12) Patent Application Publication
(10) Pub. No.: US 2016/0077573 A1
(43) Pub. Date: Mar. 17, 2016

(54) TRANSMISSION APPARATUS AND RECEPTION APPARATUS FOR TRANSMISSION AND RECEPTION OF WAKE-UP PACKET, AND WAKE-UP SYSTEM AND METHOD

(71) Applicant: SAMSUNG ELECTRONICS CO., LTD., Suwon-si (KR)

(72) Inventors: Jin LEE, Daegu (KR); Ki Hun KIM, Daegu (KR)

(73) Assignee: SAMSUNG ELECTRONICS CO., LTD., Suwon-si (KR)

(21) Appl. No.: 14/753,291

(22) Filed: Jun. 29, 2015

(30) Foreign Application Priority Data
Sep. 16, 2014 (KR) 10-2014-0122615
Feb. 24, 2015 (KR) 10-2015-0025647

(51) Int. Cl. G06F 1/32

(52) U.S. Cl. CPC G06F 1/3209

(57) ABSTRACT

A transmission apparatus includes a controller configured to generate a wake-up packet including wake-up information for waking up a reception apparatus and operational information for setting a function to be performed by the reception apparatus in response to a wake-up of the reception apparatus; and a communicator configured to perform communication with the reception apparatus to transmit the wake-up packet to the reception apparatus.

### CROSS-REFERENCE TO RELATED APPLICATIONS

This application claims priority from Korean Patent Application Nos. 10-2014-0122615 and 10-2015-0025647, filed on Sep. 16, 2014 and Feb. 24, 2015, respectively, in the Korean Intellectual Property Office, the disclosures of which are incorporated herein by reference in their entireties.

### BACKGROUND

1. Field

Apparatuses and methods consistent with exemplary embodiments relate to a transmission apparatus and a reception apparatus for transmission and reception of a wake-up packet, a wake-up system, and a wake-up method.

2. Description of the Related Art

Electronic devices may be connected to various external devices through various networks or communication systems. Technology for remotely controlling various external devices such as a television (TV), an audio player, a printer, and a computer is being developed together with technological developments in networks or communication systems. Further, studies for minimizing power consumption of the devices used for wireless personal area networks or sensor networks are actively being performed.

As an example of a scheme of minimizing the power consumption of the external devices, the external devices may be maintained in a sleep mode when the communication is not needed, and a method of waking up the external devices may be applied only when the communication is needed. In this case, the wake-up method may be performed remotely.

Various wake-up methods may be used as a method for waking up the external devices. For example, in order to wake up the external devices, the electronic device transmits a packet including a wake-up control command to the external device, and the external device receives the packet and is turned on according to the wake-up control command included in the packet. However, a subsequent function to be after waking up the external device needs to be determined. Accordingly, technology for setting the subsequent function is needed.

### SUMMARY

One or more exemplary embodiments provide a transmission apparatus and a reception apparatus for transmission and reception of a wake-up packet, a wake-up system, and a wake-up method.

Additional aspects of the invention will be set forth in part in the description which follows and, in part, will be obvious from the description, or may be learned by practice of the exemplary embodiments.

According to an aspect of an exemplary embodiment, there is provided a transmission apparatus including: a controller configured to generate a wake-up packet including wake-up information for waking up a reception apparatus and operational information for setting a function to be performed by the reception apparatus in response to a wake-up of the reception apparatus; and a communicator configured to perform communication with the reception apparatus to transmit the wake-up packet to the reception apparatus.

The reception apparatus may include a plurality of reception apparatuses.

The wake-up packet may include a header, the wake-up information, and the operational information.

The wake-up information may include a wake-up identification (ID) and a wake-up address.

The wake-up ID may include a control command for performing the wake-up of the reception apparatus.

The wake-up ID may be provided using at least one from among a wake on local area network (WOL) and a wake on wireless local area network (WoWLAN).

The wake-up address may include ID information of the reception apparatus, which is selected to perform the wake-up among a plurality of reception apparatuses.

The wake-up address may include a media access control (MAC) address of the reception apparatus.

The operational information may include a control command for setting the function to be performed by the reception apparatus in response to the wake-up of the reception apparatus.

The operational information may include an operation code corresponding to the function to be performed by the reception apparatus in response to the wake-up of the reception apparatus.

The wake-up packet may further include password information, the password information including at least one from among a password for waking up the reception apparatus and a password for setting the function.

The wake-up packet may include a first packet including the wake-up information, and a second packet including the operational information.

The communicator may be configured to sequentially transmit the first packet and the second packet.

According to an aspect of an exemplary embodiment, there is provided a reception apparatus including: a communicator configured to perform communication with a transmission apparatus to receive, from the transmission apparatus, a wake-up packet including wake-up information for waking up the reception apparatus and operational information for setting a function to be performed by the reception apparatus in response to a wake-up of the reception apparatus; and a controller configured to control to perform the wake-up of the reception apparatus based on the wake-up information and set the function to be performed in response to the wake-up of the reception apparatus based on the operational information.

The communicator may be configured to sequentially receive a first packet including the wake-up information and a second packet including the operational information.

According to an aspect of an exemplary embodiment, there is provided a wake-up system including: a transmission apparatus configured to transmit a data packet; and a reception apparatus configured to receive the data packet, wherein the transmission apparatus is configured to generate a wake-up packet, the wake-up packet including wake-up information for waking up the reception apparatus and operational information for setting a function to be performed by the reception apparatus in response to a wake-up of the reception apparatus, and transmit the wake-up packet to the reception apparatus, and the reception apparatus is configured to receive the wake-up packet from the transmission apparatus, perform the wake-up of the reception apparatus based on the wake-up information, and set the function to be performed after the wake-up based on the operational information.

According to an aspect of an exemplary embodiment, there is provided a wake-up method including: receiving, by a reception apparatus, a data packet from a transmission apparatus; determining, by the reception apparatus, whether the received data packet is a wake-up packet including wake-up information for waking up the reception apparatus and operational information for setting a function to be performed by the reception apparatus in response to a wake-up of the reception apparatus; and performing, by the reception apparatus, the wake-up based on the wake-up information in response to determining that the received packet is the wake-up packet and setting the function to be performed after the wake-up based on the operational information.

The wake-up information may include a wake-up ID and a wake-up address.

The determining may include determining whether the wake-up ID is included in the received data packet.

The wake-up address may include ID information of the reception apparatus that is selected to perform the wake-up.

The performing may include determining whether ID information of the reception apparatus is identical to the ID information of the wake-up address and performing the wake-up when the ID information of the reception apparatus is identical to the ID information of the wake-up.

The wake-up packet may further include password information, the password information including at least one from among a password for the wake-up and a password for setting the function.

The above method may further include determining whether an input password is identical to the password included in the password information.

The receiving may include sequentially receiving a first packet including the wake-up information and a second packet including the operational information.

The above method may further include determining whether an input password is identical to the password included in the password information.

According to an aspect of an exemplary embodiment, there is provided a reception apparatus including: at least one memory operable to store program code; at least one processor operable to read the program code and operate as instructed by the program code, the program code including: wake-up code configured to cause the at least one processor to perform a wake-up of the reception apparatus from a standby mode in response to receiving a wake-up packet, wherein the wake-up packet includes information about a function to be performed in response to the wake-up of the reception apparatus; and function setting code configured to cause the at least one processor to perform the function in response to the wake-up of the reception apparatus.

The at least one memory may be configured to store a plurality of operation codes corresponding to a plurality of functions capable of being performed by the reception apparatus, and the wake-up packet may include information about at least one of the plurality of operation codes.

At least one function may be selected among the plurality of functions according to a user input and an operation code of the selected at least one function is included in the wake-up packet.

The function setting code may cause the at least one processor to automatically perform the function in response to the wake-up of the reception apparatus.

### BRIEF DESCRIPTION OF THE DRAWINGS

The above and/or other aspects will become more apparent by describing certain exemplary embodiments with reference to the accompanying drawings in which:

FIG. 1 is a schematic diagram illustrating a wake-up system in accordance with an exemplary embodiment;

FIG. 2A is a schematic diagram illustrating a wake-up system in accordance with another exemplary embodiment;

FIG. 2B is a schematic diagram illustrating a wake-up system in accordance with still another exemplary embodiment;

FIG. 3 is a schematic diagram illustrating a wake-up system in accordance with still another exemplary embodiment;

FIG. 4 is a block diagram illustrating an example of a wake-up system according to an exemplary embodiment;

FIG. 5 is a schematic diagram illustrating a structure of a wake-up packet in accordance with an exemplary embodiment;

FIG. 6 is a diagram illustrating a procedure in which a wake-up packet is generated according to an exemplary embodiment;

FIG. 7 is a schematic diagram illustrating a structure of a wake-up packet in accordance with another exemplary embodiment;

FIGS. 8A and 8B are diagrams for describing wake-up information of a wake-up packet;

FIG. 9 is a diagram for describing operational information of a wake-up packet according to an exemplary embodiment;

FIGS. 10A and 10B are schematic diagrams illustrating a structure of a wake-up packet in accordance with still another exemplary embodiment;

FIGS. 11A and 11B are diagrams illustrating a structure of a wake-up packet in accordance with still another exemplary embodiment;

FIG. 12 is a diagram for describing wake-up information in accordance with an exemplary embodiment;

FIGS. 13A and 13B are diagrams for describing an operation of setting a screen mirroring function;

FIG. 14 is a flowchart for describing a wake-up method in accordance with an exemplary embodiment;

FIG. 15 is a flowchart for describing a wake-up method in accordance with another exemplary embodiment; and

FIG. 16 is a flowchart for describing a wake-up method in accordance with still another exemplary embodiment.

### DETAILED DESCRIPTION

Hereinafter, exemplary embodiments will be more explicitly described in detail with reference to the accompanying drawings. In the explanation of the exemplary embodiments, a detailed description related to a well-known structures that may obscures the scope of the disclosure may be omitted.

Hereinafter, a transmission device and a reception device using a wake-up packet, a wake-up system, and a wake-up method will be described in detail with reference to the accompanying drawings. Like reference numerals represent like components.

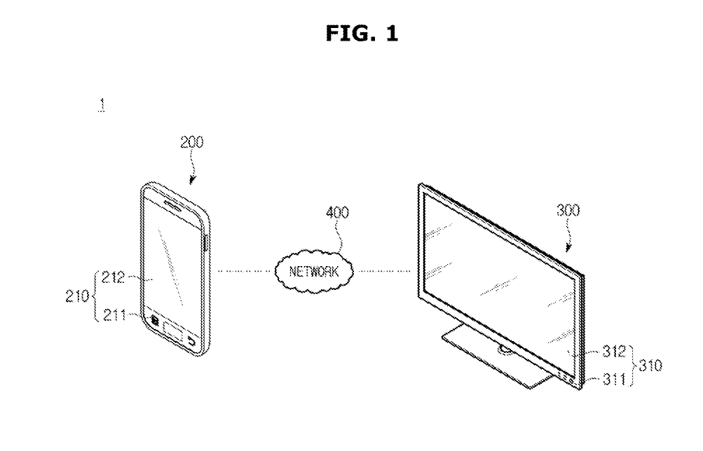

FIG. 1 is a schematic diagram illustrating a wake-up system in accordance with an exemplary embodiment.

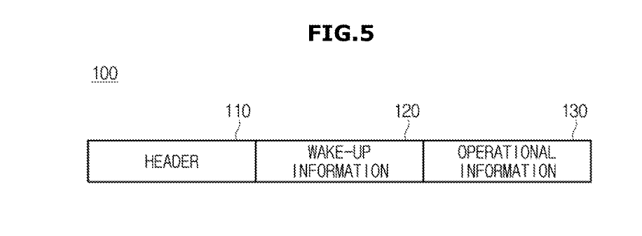

Referring to FIG. 1, a wake-up system 1 may include a transmission device 200 transmitting a wake-up packet (refer to 100 of FIG. 5) and a reception device 300 receiving the wake-up packet, and the transmission device 200 and the reception device 300 may be connected via a wired or wireless network 400. In other words, the wake-up packet 100 transmitted by the transmission device 200 may be transmitted to the reception device 300 via the network 400. Here, the wake-up packet 100 may be a packet including wake-up information for waking up the reception device 300 and operational information for setting a function to be performed after waking up. Detailed description with respect to the wake-up packet 100 will be described below.

The transmission device 200 may generate at least one wake-up packet 100, and transmit the generated wake-up packet 100 to the reception device 300. For example, the transmission device 200 may generate the wake-up packet 100 based on an input of a user.

The transmission device 200 may determine a function to be performed by the reception device 300 after waking up based on the input of the user, and include the operational information for setting the determined function in the wake-up packet 100. The user may input a wake-up command for waking up the reception device 300 and a function command to be performed after waking up to the transmission device 200. Accordingly, the transmission device 200 may generate the wake-up packet 100 including the wake-up information and the operational information based on the wake-up command and the function command of the user. Alternatively, the user may input only the function command, and the transmission device 200 may generate the wake-up packet 100 including the wake-up information and the operational information according to the input of the function command of the user.

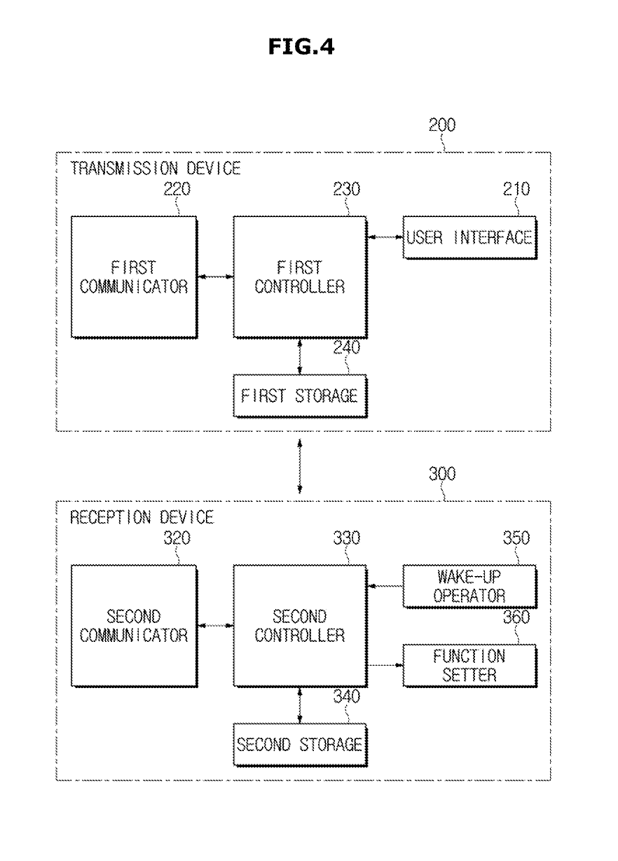

The transmission device 200 may set the reception device 300 to wake up based on the input of the user. The user may input the reception device 300 to wake up through a user interface 210 (refer to FIG. 4) included in the transmission device 200, and select the reception device 300 by control (e.g., directional control) of the transmission device 200. Accordingly, the transmission device 200 may set the reception device 300 based on the input of the user through the user interface 210. Alternatively, for example, the transmission device 200 may sense a direction according to the operation of the user, and set the reception device 300 facing the transmission device 200 as the reception device 300 to wake up.

The transmission device 200 may include identification information of the set reception device 300 in the wake-up packet 100. The reception device 300 may determine whether the wake-up packet 100 transmitted from the transmission device 200 is received based on the identification information included in the wake-up packet 100. Accordingly, the generated wake-up packet 100 may be transmitted to the set reception device 300, and wake up or operate the set reception device 300.

The user interface 210 included in the transmission device 200 may include an input unit 211 and a display 212, as shown in FIG. 4.

The input unit 211 may include a hardware input device such as various types of, for example, a button, a switch, a pedal, a keyboard, a mouse, a track ball, a lever, a handle, and a stick for the input of the user. The input unit 211 may include a graphic user interface (GUI) such as a touch pad, that is, a software input device, for the input of the user. The touch pad may be implemented as a touch screen panel (TSP) and have a mutual layer structure with the display 212.

The display 212 may be provided as a cathode ray tube (CRT), a digital light processing (DLP) panel, a plasma display panel, a liquid crystal display (LCD) panel, an electro luminescence (EL) panel, an electrophoretic display (EPD) panel, an electric chromic display (ECD) panel, a light emitting diode (LED) panel, or an organic light emitting diode (OLED) panel, but the exemplary embodiments are not limited thereto.

As described above, when the input unit 211 is configured as the TSP having the mutual layer structure with the touch pad, the display 212 may also be used as the input device.

The reception device 300 may receive the wake-up packet 100, be turned on based on wake-up information included in the wake-up packet 100, and perform an operation of setting a set function based on the operational information included in the wake-up packet 100. At this time, the reception device 300 receiving the wake-up packet 100 may include all of the reception devices 300 connected to the transmission device 200 through the network. Alternatively, only the reception device 300 selected by the user among the reception devices 300 connected to the transmission device 200 may receive the wake-up packet 100. Further, power may be turned on based on the wake-up information, and the reception device 300 performing the operation based on the operational information may be the reception device 300 selected by the user.

A user interface 310 may be included in the reception device 300, similar to in the transmission device 200, and the user interface 310 included in the reception device 300 may include an input unit 311 and a display 312. The input unit 311 and the display 312 may correspond to the input unit 211 and the display 212 of the transmission device 200, and thus detailed description thereof will be omitted. However, the reception device 300 may not include the user interface 310, or may include only one among the input unit 311 and the display 312.

As shown in FIG. 1, the transmission device 200 may include a terminal such as a smart phone and a personal digital assistant (PDA). Further, as shown in FIG. 1, the reception device 300 may be a single electronic device such as a television (TV). In other words, the wake-up packet 100 may be transmitted to the single reception device 300, and wake up or operate the single reception device 300.

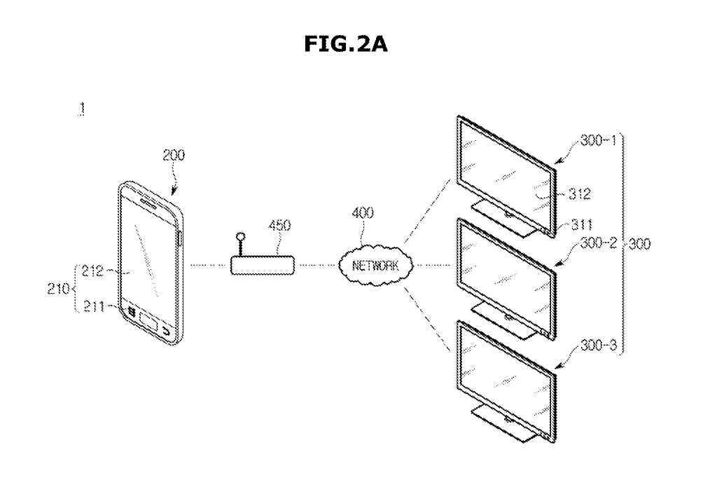

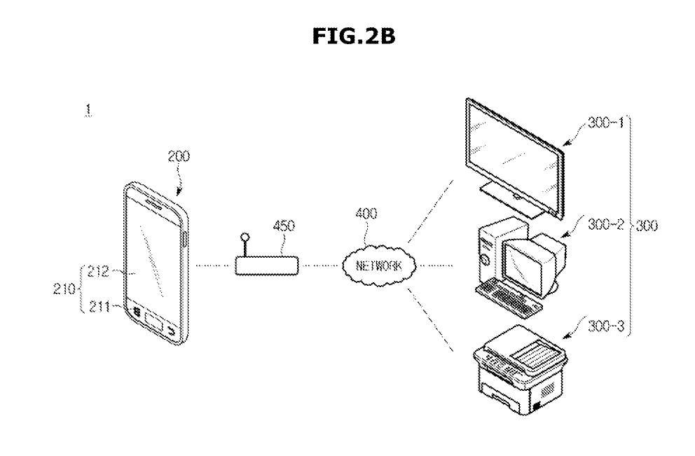

FIG. 2A is a schematic diagram illustrating a wake-up system in accordance with another exemplary embodiment.

Referring to FIG. 2A, a wake-up system 1 may include a transmission device 200 transmitting a wake-up packet 100, and a reception device 300 receiving the wake-up packet 100, and the transmission device 200 and the reception device 300 may be connected through an access point (AP) 450 and a wired or wireless network 400. In other words, the wake-up system 1 may further include an access point (AP) 450 according to a type of the transmission device 200 or the reception device 300. The transmission device 200 and the reception device 300 which are located within a predetermined distance from the AP 450 may be connected through the network 400, and the network 400 may transmit the wake-up packet 100 generated in the transmission device 200 to the reception device 300 connected thereto.

Further, there may be a plurality of reception devices 300, as shown in FIGS. 2A and 2B. In FIG. 2A, the reception device 300 may include a first reception device 300_1, a second reception device 300_2, and a third reception device 300_3, and the first reception device 300_1, the second reception device 300_2, and the third reception device 300_3 may be provided as electronic devices of the same type. FIG. 2A is only an example, and the reception device 300 may be provided in any number of the reception devices 300.

Each of the reception devices 300-1 to 300-3 connected to the transmission device 200 may receive the wake-up packet 100 from the transmission device 200. Alternatively, only the reception device 300 selected by the user among the reception devices 300-1 to 300-3 connected to the transmission device 200 may receive the wake-up packet 100. In an exemplary embodiment, the reception device 300 selected by the user may be turned on based on the wake-up information and perform the operation based on the operational information.

For example, when the second reception device 300_2 is selected by the user while all of the first reception device 300_1, the second reception device 300_2, and the third reception device 300_3 receive the wake-up packet 100, only the second reception device 300_2 may be turned on and perform the operation according to the wake-up packet 100. In another example, only the second reception device 300_2 selected by the user may receive the wake-up packet 100, and may be turned on and perform the operation according to information of the wake-up packet 100.

FIG. 2B is a schematic diagram illustrating a wake-up system in accordance with still another exemplary embodiment.

Referring to FIG. 2B, a wake-up system 1 may include a transmission device 200 transmitting a wake-up packet 100, and a reception device 300 receiving the wake-up packet 100, and the transmission device 200 and the reception device 300 may be connected through an AP 450 and a wired or wireless network 400.

At this time, the reception device 300 may include a plurality of reception devices 300, and the plurality of reception devices 300 may be provided as electronic devices of different types. For example, the first reception device 300_1 may be a TV, the second reception device 300_2 may be a computer, and the third reception device 300_3 may be a printer. Further, the AP 450 may not be included in the wake-up system 1 according to types of the transmission device 200 and/or the reception device 300.

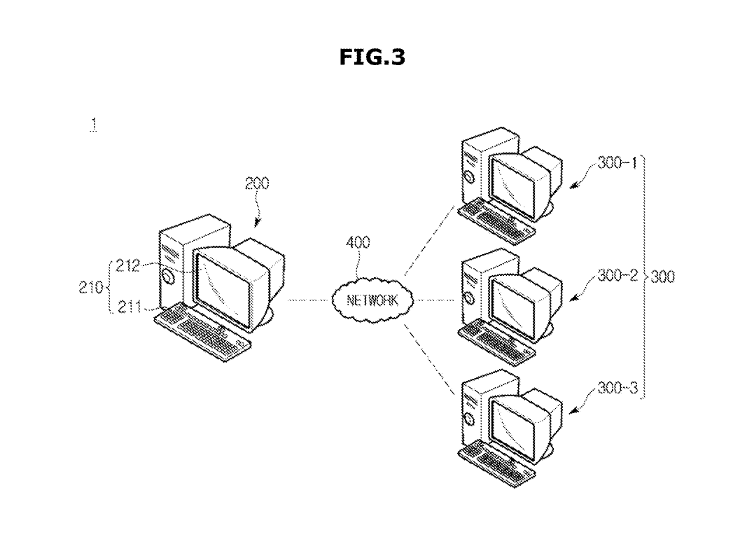

FIG. 3 is a schematic diagram illustrating a wake-up system in accordance with still another exemplary embodiment.

Referring to FIG. 3, a wake-up system 1 may include a transmission device 200 transmitting a wake-up packet 100 and a reception device receiving the wake-up packet 100, and the transmission device 200 and the reception device 300 may be connected through a wired or wireless network 400.

At this time, the transmission device 200 and the reception device 300 may be devices of the same type. For example, the transmission device 200 and the reception device 300 may correspond to computers. For example, subcomputers 300_1, 300_2, and 300_3 may be provided as the reception device 300, and a main computer controlling the subcomputers 300_1, 300_2, and 300_3 may be provided as the transmission device 200.

FIG. 4 is a block diagram illustrating an example of a wake-up system according to an exemplary embodiment.

Referring to FIG. 4, a wake-up system 1 may include the transmission device 200 and the reception device 300. The transmission device 200 may include a user interface 210, a first communicator 220, a first controller 230, and a first storage 240, and the reception device 300 may include a second communicator 320, a second controller 330, a wake-up operator 350, a function setter 360, and a second storage 340.

As described above, the user interface 210 may include an input unit 211 and a display 212, receive a user command, and provide a user interface function. The user may select the reception device 300 to perform wake-up and function setting operations according to the information of the wake-up packet 100 through the user interface 210. The user may select a function to be performed after waking up through the user interface 210.

The first communicator 220 may transmit the wake-up packet 100 generated through the first controller 230 to the reception device 300. The first communicator 220 may be connected to at least one reception device 300 through the wired or wireless network 400. The first communicator 220 may transmit the wake-up packet 100 to each of the reception devices 300 connected to the first communicator 220, or transmit the wake-up packet 100 to only the reception device 300 selected by the user.

The first communicator 220 may include various communicators such as a wireless Internet communicator, a local area communicator, and a mobile communicator.

The wireless Internet communicator may perform communication while connected to an external network according to a communication protocol such as, for example but not limited to, a wireless local area network (WLAN), Wi-Fi, wireless broadband (Wibro), world interoperability for microwave access (Wimax), and high-speed downlink packet access (HSDPA).

The local area communicator may perform communication with the external device which is located in a local area according to a local area communication method such as, for example but not limited to, Bluetooth, radio frequency identification (RFID), infrared data association (IrDA), ultra-wideband (UWB), and Zigbee.

The mobile communicator may perform communication while connected to a mobile communication network according to various mobile communication standards such as, for example but not limited to, third generation (3G), third generation partnership project (3GPP), and long-term evolution (LTE).

However, the first communicator 220 is not limited thereto. In addition, when the first communicator 220 performs communication with the reception device 300 and transmits the packet or information included in the packet, the first communicator 220 may be a communicator of a different type in addition to the communicators described above.

The first controller 230 may generate the wake-up packet 100. Here, as described above, the wake-up packet 100 may be defined as at least one packet including wake-up information for waking up the reception device 300 and operational information for setting a function to be performed after waking up. That is, the wake-up information and the operational information may be transmitted through a plurality of packets.

The reception device 300 to which the wake-up packet 100 is transmitted may be the reception device 300 selected by the user, but is not limited thereto.

Particularly, the wake-up packet 100 may be transmitted to only the reception device 300 selected by the user, or may be transmitted to some or all of the reception devices 300 connected to the network 400. When the wake-up packet is transmitted to all of the reception devices 300, the reception device 300 may determine whether to receive the wake-up packet 100 based on the identification information included in the wake-up packet 100. That is, the reception device 300 may process the wake-up packet 100 based on the identification information that corresponds to the reception device 300, and may not process the wake-up packet 100 when the identification information of the wake-up packet 100 does not correspond to the reception device 300.

FIG. 5 is a schematic diagram illustrating a structure of a wake-up packet in accordance with an exemplary embodiment.

Referring to FIG. 5, the first controller 230 may generate wake-up information 120 for waking up the reception device 300 and operational information 130 for setting a function to be performed by the reception device 300 after waking up based on the selection of the user, and transmit the wake-up packet 100 including the wake-up information 120 and the operational information 130 to the reception device 300.

The wake-up information 120 and the operational information 130 may be included in the wake-up packet 100, as shown in FIG. 5.

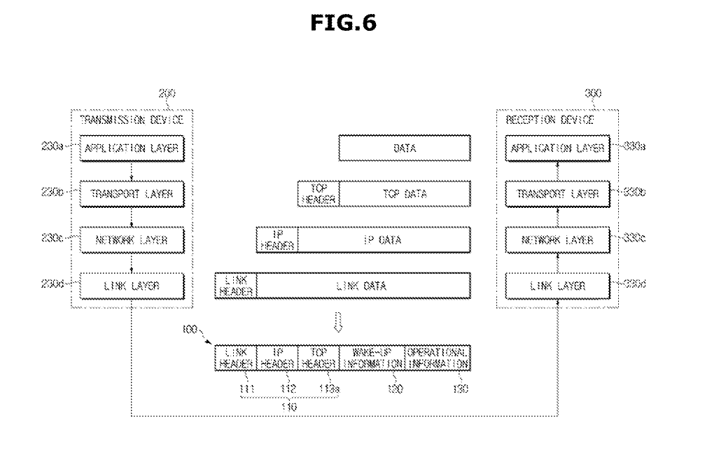

Particularly, the first controller 230 may generate the wake-up packet 100 including a header 110, the wake-up information 120, and the operational information 130. The wake-up packet 100 may include the wake-up information 120 including a control command or control information for waking up the reception device 300 selected by the user. Further, the wake-up packet 100 may include the operational information 130 including the control command or the control information for setting a function selected by the user to be performed after the reception device 300 is waken up. Moreover, the wake-up packet 100 may include the header 110 in front of the wake-up information 120 and the operational information 130. The header 110 may be generated according to a network method or a protocol type, etc. between the transmission device 200 and the reception device 300. Detailed description thereof will be described with reference to FIG. 6.

FIG. 6 is a diagram illustrating a procedure in which a wake-up packet is generated according to an exemplary embodiment.

As shown in FIG. 6, a hierarchical structure of the wake-up system 1 may include link layers 230d and 330d, network layers 230c and 330c, transport layers 230b and 330b, and application layers 230a and 330a. Particularly, the transmission device 200 or the first controller 230 of the transmission device 200 may include the link layer 230d, the network layer 230c, the transport layer 230b, and the application layer 230a, and similarly, the reception device 300 or the second controller 330 of the reception device 300 may include the link layer 330d, the network layer 330c, the transport layer 330b, and the application layer 330a. The wake-up packet 100 may be formed by passing through a plurality of layers included in the transmission device 200 to accumulate data.

The application layer 230a may generate data to be transmitted. Here, the data to be transmitted may include wake-up information 120 and operational information 130. Further, the application layer 230a may perform a function of converting a format of the generated data into a data format of the reception device 300.

Data may be added to the data passed through the application layer 230a in the transport layer 230b, and thus transport layer data (for example, transmission control protocol (TCP) data) may be generated. Further, in the transport layer 230b, a header may be attached to the transport layer data. For example, as shown in FIG. 6, data of the application layer 230a may be provided in a TCP packet form in which a TCP header and TCP data are combined in the transport layer 230b.

Data may be added to the data transmitted from the transport layer 230b in the network layer 230c, and the network layer data (for example, Internet protocol (IP) data) may be generated. Further, the network layer 230c may add a header to the network layer data. For example, the TCP packet generated in the transport layer 230b may be provided in an IP packet format in which an IP header and the IP data are combined in the network layer 230c.

Data may be added to the data transmitted from the network layer 230c in the link layer 230d, and the link layer data may be generated. Further, in the network layer 230c, a header may be attached to the link layer data. For example, the header of the link layer may be provided in a media access control (MAC) header format, or in an Ethernet header format.

As such, the wake-up packet 100 may be finally generated by passing through the application layer 230a, the transport layer 230b, the network layer 230c, and the link layer 230d of the transmission device 200, and as shown in FIG. 6, the wake-up packet 100 may be configured as data including the wake-up information 120 and the operational information 130, and a header 110 including a link header 111, an IP header 112, and a TCP header 113a.

Here, the header 110 may include address information of the transmission device 200 transmitting the wake-up packet 100, and address information of the reception device 300 receiving the wake-up packet 100. The link header 111 may include the MAC address or the Ethernet address of the transmission device 200 and/or the reception device 300. The IP header 112 may include the IP address of the transmission device 200 and/or the reception device 300. The TCP header 113a may include a port address of the transmission device 200 and/or the reception device 300.

Address information of the transmission device 200 transmitting the wake-up packet 100 and the reception device 300 receiving the wake-up packet 100 may be included in the wake-up packet 100 as separate data. The address information including the MAC address or the Ethernet address, the IP address, and the port address of the transmission device 200 and the reception device 300 may be separately included in the wake-up packet 100. In this case, unlike the wake-up packet 100 shown in FIG. 6, the wake-up packet 100 may be provided to include the header 110, the wake-up information 120, the operational information 130, and the address information.

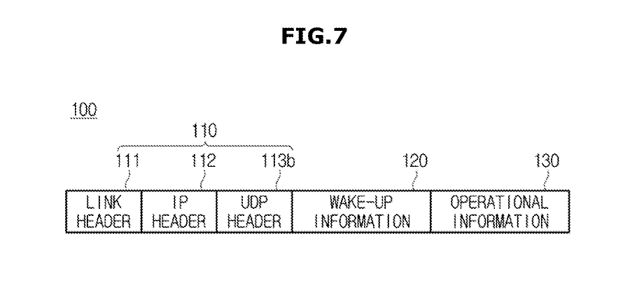

FIG. 7 is a schematic diagram illustrating a structure of a wake-up packet in accordance with another exemplary embodiment.

The wake-up packet 100 may be provided as data including the wake-up information 120 and the operational information 130, and at this time, may include a link header 111, an IP header 112, and a user datagram protocol (UDP) header 113b, as shown in FIG. 7. That is, the wake-up packet 100 may be generated by sequentially attaching the UDP header 113b, the IP header 112, and the link header 111 to the data including the wake-up information 120 and the operational information 130.

The wake-up packet 100 generated in the transmission device 200 may be transmitted to the reception device 300. At this time, the reception device 300 to receive the wake-up packet 100 may be determined based on the address information of the reception device 300 included in the wake-up packet 100. In other words, when the wake-up packet 100 includes the address information of each of the reception devices 300 connected to the transmission device 200, the wake-up packet 100 may be transmitted to the each of the reception devices 300. Further, when the wake-up packet 100 includes the address information of one reception device 300 among the reception devices 300 connected to the transmission device 200, the wake-up packet 100 may be transmitted only to the reception device 300 corresponding to the address information.

The wake-up packet 100 may be transmitted to the link layer 330d of the reception device 300, and the wake-up packet 100 or the data included in the wake-up packet 100 may be read while passing through the link layer 330d, the network layer 330c, the transport layer 330b, and the application layer 330a. Detailed description of a read operation of the reception device 300 will be described below.

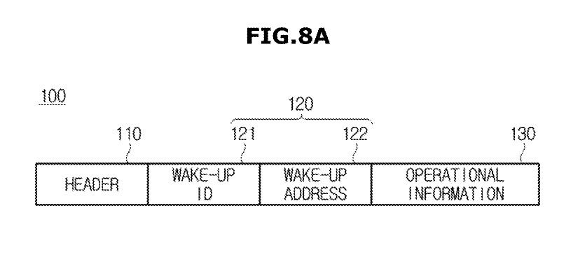

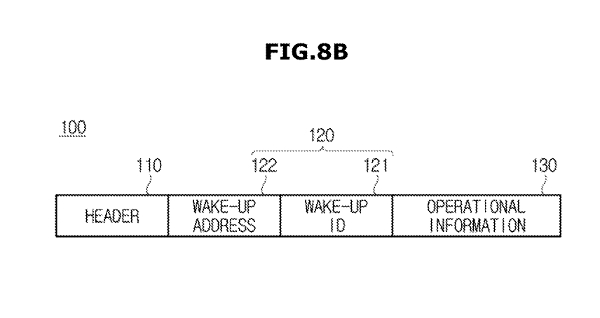

FIGS. 8A and 8B are diagrams for describing wake-up information of a wake-up packet according to an exemplary embodiment.

Referring to FIGS. 8A and 8B, the wake-up information 120 configuring the wake-up packet 100 may include a wake-up identification (ID) 121, and a wake-up address 122.

The wake-up ID 121 may be a control command for waking up, that is, a control command for turning on the external device or for waking up the external device from a sleep mode (or standby mode), and may be provided using a wake on local area network (WOL) and/or wake on wireless local area network (WoWLAN), but the exemplary embodiments are not limited thereto.

The wake-up address 122 may refer to ID information of the reception device 300 to wake up. As described above, the user may select the reception device 300 to wake up, and at this time, the reception device 300 to wake up may be referred to as a wake-up device. That is, the user may select the wake-up device, the first controller 230 may use the ID information of the wake-up device, for example, the MAC address of the wake-up device as the wake-up address 122 based on the selection of the user, and include the wake-up address 122 in the wake-up information 120. The reception device 300 may determine whether the wake-up address 122 included in the wake-up information 120 is identical to its own ID information, and determine whether to perform the wake-up based on the determination result. Detailed description thereof will be described below.

The first controller 230 may sequentially arrange the wake-up ID 121 and the wake-up address 122, and generate the wake-up information 120. As shown in FIG. 8A, the first controller 230 may generate the wake-up information 120 so that the wake-up address 122 is arranged after the wake-up ID 121, and as shown in FIG. 8B, the first controller 230 may generate the wake-up information 120 so that the wake-up ID 121 is arranged after the wake-up address 122. However, the exemplary embodiments are not limited to an arrangement sequence as described above.

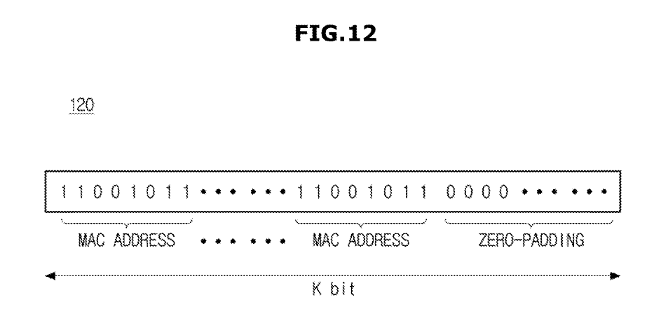

For example, the wake-up information 120 may be provided according to a predetermined standard protocol prescribed to wake up the reception device 300. This will be described in detail in FIG. 12.

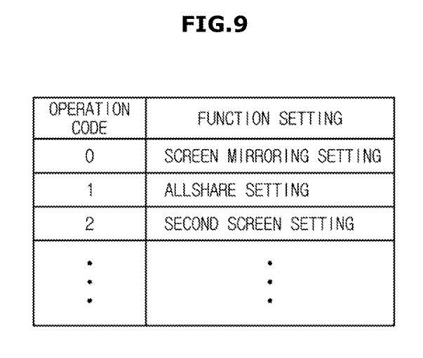

FIG. 9 is a diagram for describing operational information of a wake-up packet according to an exemplary embodiment.

Referring to FIG. 9, the operational information 130 may be information of an operation of setting a function to be performed by the reception device 300 after waking up. The operational information 130 may include a control command for setting the function, and may be provided as an operation code corresponding to the function.

For example, when the reception device 300 is a smart television, the reception device 300 may perform a screen mirroring function, an allshare function, a second screen function, etc. The first storage 240 of the transmission device 200 may store in advance the operation code corresponding to the function of the reception device 300. For example, the first storage 240 may store the operation code “0” corresponding to the operation of setting the screen mirroring function, store the operation code “1” corresponding to the operation of setting the allshare function, and store the operation code “2” corresponding to the operation of setting the second screen function.

When the function to be performed after waking up is selected by the input of the user, the first controller 230 of the transmission device 200 may use the operation code of setting the function selected among the operation codes stored in the first storage 240 as the operational information 130, and include the operation code in the wake-up packet 100. In the example described above, when the user selects the screen mirroring function, the first controller 230 may include the operation code “0” of setting the screen mirroring function in the wake-up packet 100.

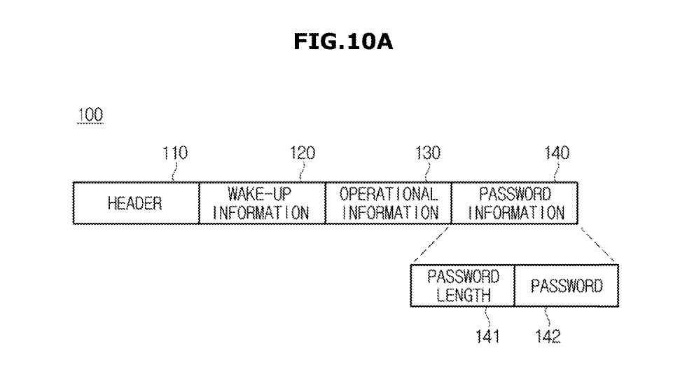

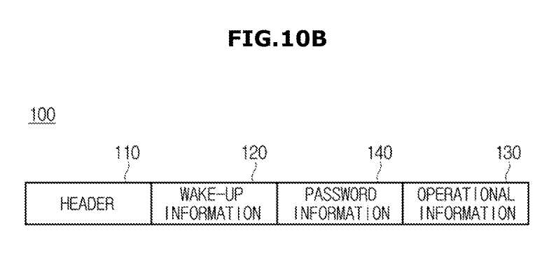

As described above, the first controller 230 may generate the wake-up packet 100 including the header 110, the wake-up information 120, and the operational information 130. The wake-up packet 100 may further include password information (140 of FIG. 10A).

FIGS. 10A and 10B are schematic diagrams illustrating a structure of a wake-up packet in accordance with another exemplary embodiment.

Referring to FIGS. 10A and 10B, the first controller 230 may generate the wake-up packet 100 including the header 110, the wake-up information 120, the operational information 130, and the password information 140. The first controller 230 may be provided to have a plurality of layers, that is, the application layer 230a, the transport layer 230b, the network layer 230c, and the link layer 230d as described above, and may generate the wake-up packet 100 in which data including the wake-up information 120, the operational information 130, and the password information 140, and the header 110 attached to the data is included. Here, since the header 110, the wake-up information 120, and the operational information 130 are described with reference to FIGS. 5 to 9, description thereof will be omitted below.

As shown in FIG. 10A, the password information 140 may include a password length 141 and a password 142. Here, the password length 141 may refer to a length of a set password. For example, the password length 141 may be 0 to 16. Particularly, when the password length 141 is 0, it may indicate that the password 142 is not set. Further, the password length 141 may be provided as a 1 byte data.

The password 142 may include a password for performing wake-up and/or a password for performing the function setting operation. Further, the password for performing the wake-up and the password for performing the function setting operation may be simultaneously provided. That is, a plurality of passwords 142 may be provided. When the password 142 is the password for performing the wake-up, the reception device 300 may perform the wake-up in response to an input of the set password, and when the password 142 is the password for performing the function setting operation, the reception device 300 may perform the function setting operation in response to the input of the set password.

The first controller 230 may generate the wake-up information 120 by sequentially arranging the wake-up information 120, the operational information 130, and the password information 140. The first controller 230 may generate the wake-up information 120 so that the password information 140 is arranged after the operational information 130, as shown in FIG. 10A, or may generate the wake-up information 120 so that the operational information 130 is arranged after the password information 140, as shown in FIG. 10B. Further, unlike FIGS. 10A and 10B, the wake-up information 120 and the operational information 130 may be sequentially arranged after the password information 140. However, the exemplary embodiments are not limited thereto.

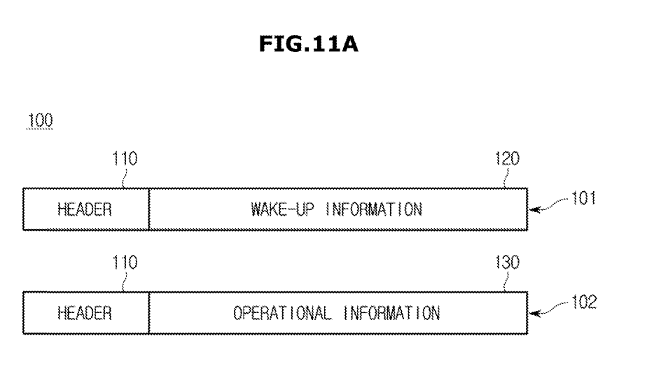

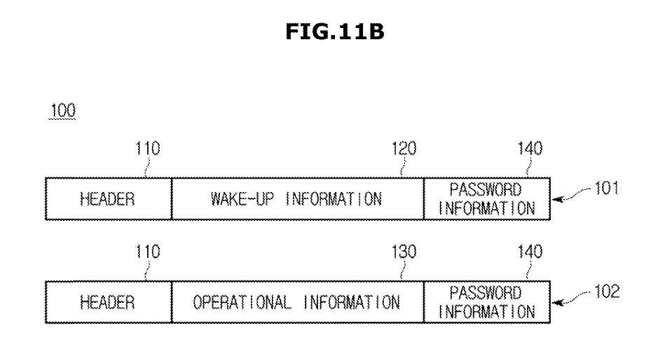

As described above, the wake-up information 120 and the operational information 130 may be provided in one wake-up packet 100 and may be transmitted together, or may be divided into a plurality of packets to be transmitted. Hereinafter, with reference to FIGS. 11 and 12, the wake-up packet 100 including the plurality of packets will be described in detail.

FIGS. 11A and 11B are diagrams illustrating a structure of a wake-up packet in accordance with still another exemplary embodiment, and FIG. 12 is a diagram for describing wake-up information in accordance with an exemplary embodiment.

Referring to FIG. 11A, the first controller 230 may generate the wake-up packet 100 by dividing the wake-up information 120 and the operational information 130 into a plurality of packets. That is, the wake-up information 120 and the operational information 130 may be included in the plurality of packets that are different from each other.

Particularly, a first packet 101 may include the header 110 and the wake-up information 120, and a second packet 102 may include the header 110 and the operational information 130. The first controller 230 of the transmission device 200 may generate the first packet 101 in which the wake-up information 120 is included and the second packet 102 in which the operational information 120 is included using the plurality of layers 230a to 230d described above.

At this time, the wake-up information 120 of the first packet 101 may be generated according to a standard protocol which is prescribed. The wake-up information 120 may be generated to have a k-bit size according to the standard protocol as shown in FIG. 12. Particularly, the first controller 230 may generate the wake-up information 120 by performing zero-padding so that the wake-up information 120 has the k-bit size after repeating the MAC address of the reception device 300 to wake up the reception device 300 a predetermined number of times (for example, eight times).

The operational information 130 of the second packet 102 may be generated according to the standard protocol which is prescribed, or only the first packet 101 may be generated according to the standard protocol which is prescribed.

The first packet 101 and the second packet 102 may further include the password information 140 as shown in FIG. 11B. At this time, the password information included in the first packet 101 and the password information included in the second packet 102 may be the same. Alternatively, the password information included in the first packet 101 and the password information included in the second packet 102 may be different. For example, the password information 140 of the first packet 101 may be information for performing the wake-up, and the password information 140 of the second packet 102 may be information for performing the function setting operation.

An example in which the password information 140 is included in both of the first packet 101 and the second packet 102 is illustrated in FIG. 11B, but the exemplary embodiments are not limited thereto. For example, the password information 140 may be included in only one of the first packet 101 and the second packet 102. As shown in FIGS. 11A and 11B, when the wake-up packet 100 includes the plurality of packets 101 and 102, the first communicator 220 may sequentially transmit the first packet 101 and the second packet 102 according to control of the first controller 230. For example, the first communicator 220 may first transmit the first packet 101 and then transmit the second packet 102, or may first transmit the second packet 102 and then transmit the first packet 101.

The first storage 240 may temporarily or permanently store data and a program for an operation of the transmission device 200. For example, the first storage 240 may store the address information of the reception device 300 connected to the transmission device 200. The first storage 240 may store the ID information of the reception device 300 which is selected by the user, that is, which is to be waken up, or the ID information of the reception device 300 connected to the transmission device 200. Further, the first storage 240 may store functions which are performed by the reception device 300, or the operation code corresponding to each function. The first storage 240 may store the function selected by the user or the operation code corresponding to the selected function. The first storage 240 may store the wake-up packet 100 generated through the first controller 230.

The first storage 240 may include a storage medium of at least one type from among a flash memory type, a hard disk type, a multimedia card micro type, and a card-type memory (for example, secure digital (SD) or extreme digital (XD) memory, etc.), a random access memory (RAM), a static random access memory (SRAM), a read only memory (ROM), an electrically erasable programmable read only memory (EEPROM), a programmable read only memory (PROM), a magnetic memory, a magnetic disk, and an optical disk. However, the first storage 240 is not limited thereto, and may be implemented in any different types which are known to those of ordinary skill in the art. Further, the transmission device 200 may operate a web storage performing a storage function on the Internet.

Referring to FIG. 4 again, the reception device 300 may include the second communicator 320, the second controller 330, the wake-up operator 350, the function setter 360, and the second storage 340. Here, the second controller 330, the wake-up operator 350, and the function setter 360 may be provided as a single processor or a single device, or may be separately provided as a plurality of processors or a plurality of devices.

The second communicator 320 may be connected to the transmission device 200 through a wired or wireless network 400 and receive the wake-up packet 100 from the transmission device 200. The second communicator 320 may include various communicators such as a wireless Internet communicator, a local area communicator, and a mobile communicator. Since the wireless Internet communicator, the local area communicator, and the mobile communicator may be the same as those described with reference to the first communicator 220 of the transmission unit 200, description thereof will be omitted. Further, when communicating with the transmission device 200 and receiving a packet or information included in the packet, the second communicator 320 may apply another type of a communicator other than the communicators described above.

Particularly, the second communicator 320 may receive at least one wake-up packet 100 transmitted through the wired or wireless network 400. As shown in FIGS. 5 and 10, when the wake-up information 120 and the operational information 130 are transmitted in one wake-up packet 100, one wake-up packet 100 may be received, and when the wake-up packet 100 is configured as the plurality of packets 101 and 102, the plurality of packets 101 and 102 may be received.

The second controller 330 may read the received wake-up packet 100. The second controller 330 may be provided as a plurality of layers, that is, the application layer 330a, the transport layer 330b, the network layer 330c, and the link layer 330d as shown in FIG. 6, and the second controller 330 may read data of the wake-up packet 100. The wake-up packet 100 may be transmitted to the link layer 330d through the second communicator 320, and the header 100 corresponding to each layer may be excluded from the wake-up packet 100 while the wake-up packet 100 sequentially passes through the link layer 330d, the network layer 330c, the transport layer 330b, and the application layer 330a.

For example, when the wake-up packet 100 includes the link header 111, the IP header 112, the TCP header 113a, the wake-up information 120, and the operational information 130 as shown in FIG. 6, the link header 111 may be excluded while the wake-up packet 100 passes through the link layer 330d, the IP header 112 may be excluded while the wake-up packet 100 passes through the network layer 330c, the TCP header 113a may be excluded while the wake-up packet 100 passes through the transport layer 330b, and data including the wake-up information 120 and the operational information 130 may remain in the application layer 330a.

As shown in FIGS. 11A and 11B, when the wake-up packet 100 is configured as the plurality of packets 101 and 102, the second controller 330 may obtain the wake-up information 120 from the first packet 101 and the operational information 130 from the second packet 102 using the plurality of layers 330a to 330d described above. The second controller 330 may generate a control signal for controlling the wake-up operator 350 and the function setter 360 based on the data of the application layer 330a, that is, the wake-up information 120 and the operational information 130.

First, the second controller 330 may control the wake-up operator 350 based on the wake-up information 120. As described above, the wake-up information 120 may include the wake-up ID 121 and the wake-up address 122, and the second controller 330 may determine whether the wake-up address 122 is identical to its own ID information. When the wake-up address 122 is identical to its own ID information, the second controller 330 may control the wake-up operator 350 according to the wake-up ID. The wake-up operator 350 may turn on the reception device 300 or supply the power to the reception device 300 based on the control signal of the second controller 330. Further, when the wake-up address 122 is not identical to its own ID information, the second controller 330 may control the wake-up operator 350 to maintain the sleep mode.

For example, when the wake-up address 122 is provided as the MAC address, the second controller 330 may determine whether the MAC address of the wake-up device is identical to its own MAC address, control the wake-up operator 350 to perform the wake-up when the MAC address of the wake-up device is identical to its own MAC address, and control the wake-up operator 350 to maintain in the sleep mode when the MAC address of the wake-up device is not identical to its own MAC address.

As shown in FIG. 12, when the wake-up information 120 is generated according to a standard protocol which is prescribed, the second controller 330 may obtain the wake-up information 120 from the first packet 101, and control the wake-up operator 350 based on the obtained wake-up information 120. For example, the second controller 330 may obtain a repeated MAC address from the wake-up information 120, control the wake-up operator 350 to perform the wake-up when the obtained MAC address is identical to its own MAC address, and control the wake-up operator 350 to maintain the sleep mode when the obtained MAC address is not identical to its own MAC address.

The second controller 330 may control the function setter 360 based on the operational information 130. As describe above, the operational information 130 may be provided in a form of the operation code, and the operation code may refer to an operation code for setting a function selected by the user among functions capable of being performed by the reception device 300. The second controller 330 may control the function setter 360 to set a function corresponding to the operation code when the reception device 300 is waken up. The second storage 340 may store in advance the operation code corresponding to each function of the reception device 300, and the second controller 330 may determine a function corresponding to an operation code by comparing the operation code stored in the second storage 340 and the operation code provided in the operational information 130, and may control the function setter 360 to set the determined function.

The operation code stored in the second storage 340 of the reception device 300 may be the same as that stored in the first storage 240 of the transmission device 200. For example, as described above, when the first storage 240 of the transmission device 200 may store the operation code “0” corresponding to the operation of setting the screen mirroring function, store the operation code “1” corresponding to the operation of setting the allshare function, and store the operation code “2” corresponding to the operation of setting the second screen function, the second storage 340 of the reception device 300 may also store the operation code “0” corresponding to the operation of setting the screen mirroring function, store the operation code “1” corresponding to the operation of setting the allshare function, and store the operation code “2” corresponding to the operation of setting the second screen function.

In an example described above, when the operation code of the operational information 130 is “0”, the second controller 330 may generate a control signal for setting the function corresponding to the operation code “0”, that is, the screen mirroring function, and the function setter 360 may set the screen mirroring function according to the control signal.

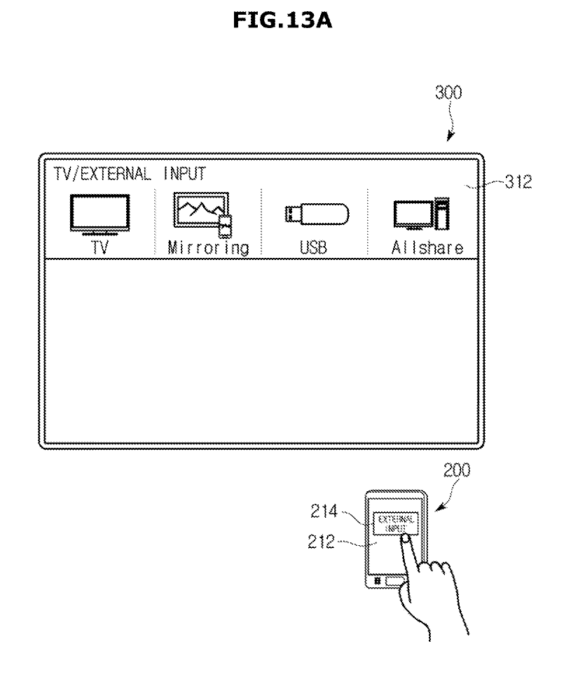

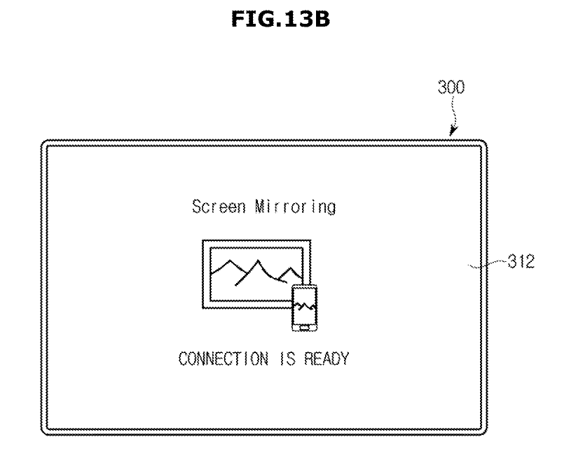

FIGS. 13A and 13B are diagrams for describing an operation of setting a screen mirroring function. In FIGS. 13A and 13B, an example in which the transmission device 200 is implemented in a portable terminal and the reception device 300 is implemented in a smart television is illustrated.

Generally, to perform the screen mirroring function of the reception device 300, the user may enter an external input selection 214 by, for example, pushing an external input button or clicking an external input icon through the user interface 210 included in the transmission device 200, as shown in FIG. 13A. According to the external input selection 214 of the user, the reception device 300 may display the user interface 310 of the reception device 300 or a screen for setting external inputs of the TV on the display 312. For example, the display 312 may display a “TV” icon for performing a conventional television function such as reception of broadcasting, a “Mirroring” icon for performing the screen mirroring function for associating with the transmission device 200, a “USB” icon for accessing and executing a file or data of a universal serial bus (USB), and an “Allshare” icon for performing the allshare function of sharing the file.

The user may select the “Mirroring” icon among the icons displayed on the display 312. The user may select the “Mirroring” icon through the user interface 210 of the transmission device 200, or select the “Mirroring” icon through the user interface 310 of the reception device 300.

According to the selection of the “Mirroring” icon of the user, the display 312 may be switched to a screen as shown in FIG. 13B. That is, a screen indicating that connection with another device providing a multimedia image of the transmission device 200 or connection with the transmission device 200 is ready may be displayed. When the reception device 300 is connected to the transmission device 200 or another device, the screen mirroring function is performed.

As described above, to perform the screen mirroring function of the reception device 300, generally, a manual input of the user may be needed. That is, the user may perform a first manual input for the selection of the external input, and a second manual input for the selection of the “Mirroring” icon. Further, to perform the screen mirroring function of the reception device 300, a screen of the reception device 300 may need to be switched. That is, the display 312 may be switched from a first screen for setting the TV/external input to a second screen indicating that the connection with the transmission device 200 or another device is ready.

On the other hand, when the second controller 330 generates the control signal for setting the screen mirroring function according to an operation code of the operational information 130, the first manual input and the second manual input of the user may be omitted. Further, an output of the first screen may be omitted. In other words, in a case where the first manual input and the second manual input are not received, the function setter 360 may still perform the operation of setting the screen mirroring function according to the control signal of the second controller 330, and immediately display the second screen as shown in FIG. 13B. In an exemplary embodiment, the function setter 360 may automatically perform the operation of setting the screen mirroring function in response to the wake-up of the reception device 300.

An example of the wake-up packet 100 including the header 110, the wake-up information 120, and the operational information 130 is illustrated and described above, and the wake-up packet 100 may further include the password information 140 as shown in FIGS. 10A, 10B, and 11B.

In this case, the second controller 330 may sequentially pass the wake-up packet 100 through the plurality of layers, i.e., the link layer 330d, the network layer 330c, the transport layer 330b, and the application layer 330a, exclude the header 100 included in the wake-up packet 100, and read the data of the wake-up packet 100, that is, the wake-up information 120, the operational information 130, and the password information 140.

The second controller 330 may control the wake-up operator 350 based on the wake-up information 120.

When the password 142 included in the password information 140 is a password for performing the wake-up, the second controller 330 may control the wake-up operator 350 based on the wake-up information 120 and the password information 140. First, the second controller 330 may determine whether an input password is identical to the password 142 of the password information 140. At this time, the input of the password may be directly input from the user through the user interface 310 or may be automatically input by the second controller 330. When it is determined that the input password is identical to the password 142 of the password information 140, the second controller 330 may control the wake-up operator 350 based on the wake-up information 120. Since the control of the wake-up operator 350 has been described above, description thereof will be omitted below.

The second controller 330 may control the function setter 360 based on the operational information 130.

When the password 142 included in the password information 140 is the password for performing the function setting operation, the second controller 330 may control the function setter 360 based on the operational information 130 and the password information 140. First, the second controller 330 may determine whether the input password is identical to the password 142 of the password information 140. When it is determined that the input password is identical to the password 142 of the password information 140, the second controller 330 may control the function setter 360 based on the operational information 130. Since the control of the function setter 360 has been described above, description thereof will be omitted below.

The second storage 340 may temporarily or permanently store data and a program for the operation of the reception device 300. For example, the second storage 340 may store the wake-up packet 100 transmitted from the transmission device 200. The second storage 340 may store in advance the operation code corresponding to each function of the reception device 300. At this time, the operation code stored in the second storage 340 may be identical to the operation code stored in the first storage 240 of the transmission device 200. Further, the second storage 340 may store its own address information and ID information.

The second storage 340 may include a storage medium of at least one type among a flash memory type, a hard disk type, a multimedia card micro type, and a memory having a card type (for example, an SD or XD memory), an RAM, an SRAM, an ROM, an EEPROM, a PROM, a magnetic memory, a magnetic disk, and an optical disk. However, the second storage 340 is not limited thereto, and may be implemented in any different types which are known to those of ordinary skill in the art. Further, the reception device 300 may operate a web storage performing a storage function on the Internet.

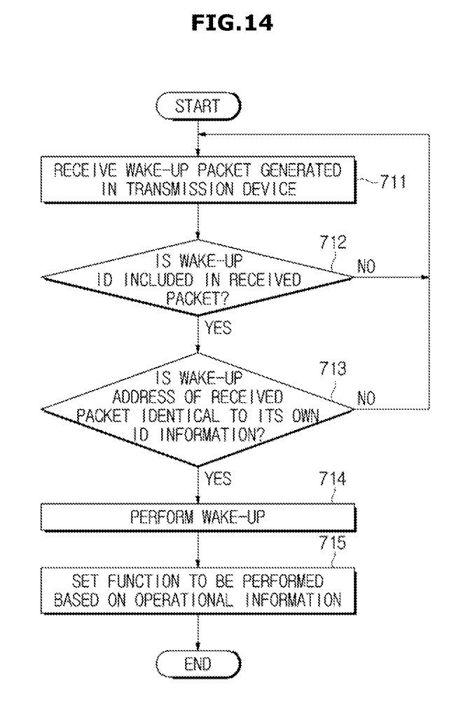

The transmission device 200 and the reception device 300 for transmitting and receiving the wake-up packet 100, and the wake-up system 1 including transmission device 200 and the reception device 300 are described based on the block diagrams of exemplary embodiments described above. Hereinafter, a wake-up method according to an exemplary embodiment will be described with reference to FIGS. 14-16.

FIG. 14 is a flowchart for describing a wake-up method in accordance with an exemplary embodiment.

Referring to FIG. 14, first, the reception device 300 may receive the wake-up packet 100 generated in the transmission device 200 (S711). Since the method in which the transmission device 200 generates the wake-up packet 100 is described above, detailed description thereof will be omitted. Further, the wake-up packet 100 may include the header 110, the wake-up information 120, and the operational information 130.

When receiving a packet from the transmission device 200, the reception device 300 may determine whether the wake-up ID 121 is included in the received packet to confirm that the received packet is the wake-up packet 100 (S712).

The reception device 300 may exclude the header of the received packet, and read the data included in the packet. The reception device 300 may determine whether the wake-up ID 121 according to the WOL and/or the WoWLAN is included in the data.

When the wake-up ID 121 is not included in the data, the reception device 300 may determine that the received packet is not the wake-up packet 100, and return to operation S711.

When the wake-up ID 121 is included in the data, the reception device 300 may determine that the received packet is the wake-up packet 100, and may determine whether the wake-up address 122 of the received wake-up packet 100 is identical to its own ID information (S713).

When its own ID information is not identical to the wake-up address 122, the reception device 300 may return to operation S711.

When its own ID information is identical to the wake-up address 122, the reception device 300 may perform the wake-up according to the wake-up ID (S714). That is, the reception device 300 may be turned on and waken up from the sleep mode.

After performing the wake-up, the reception device 300 may perform the operation of setting a function to be performed based on the operational information 130 of the received wake-up packet 100 (S715).

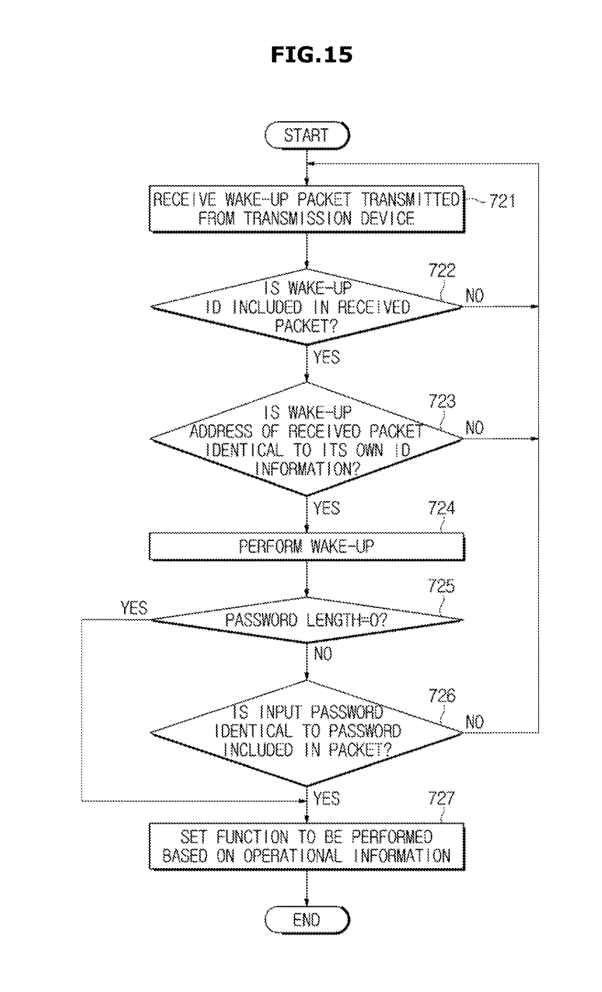

FIG. 15 is a flowchart for describing a wake-up method in accordance with another exemplary embodiment.

Referring to FIG. 15, first, the reception device 300 may receive the wake-up packet 100 generated in the transmission device 200 (S721). At this time, the wake-up packet 100 may include the header 110, the wake-up information 120, the operational information 130, and the password information 140.

Next, in order to confirm whether the received packet is the wake-up packet 100, the reception device 300 may determine whether the wake-up ID 121 is included in the received packet (S722). The reception device 300 may exclude the header of the received packet and read the data included in the packet. The reception device 300 may determine whether the wake-up ID according to the WOL and/or the WoWLAN is included in the data.

When the wake-up ID 121 is not included in the received packet, the reception device 300 may determine that the received packet is not the wake-up packet, and return to operation S721.

On the other hand, when the wake-up ID 121 is included in the received packet, the reception device 300 may determine that the received packet is the wake-up packet 100, and may determine that the wake-up address 122 of the received wake-up packet 100 is identical to its own ID information (S723).

When the wake-up address 122 of the received wake-up packet 100 is not identical to its own ID information, the reception device 300 may return to operation S721.

When the wake-up address 122 of the received wake-up packet 100 is identical to its own ID information, the reception device 300 may perform the wake-up according to the wake-up ID 121 (S724). That is, the reception device 300 may be turned on and waken up from the sleep mode.

The reception device 300 may determine whether the password length 141 included in the password information 140 is zero (S725). That is, the reception device 300 may determine whether the set password 142 exists in the wake-up packet 100.

When the password length 141 is not zero, it may be determined whether the input password is identical to the password 142 of the wake-up packet 100, that is, the password 142 included in the password information 140 (S726). Here, the password may be directly input by the user through the user interface 310 or may be automatically input by the second controller 330.

When the input password is identical to the password 142 included in the password information 140, the reception device 300 may perform the operation of setting a function to be performed based on the operational information 130 of the received wake-up packet 100 (S727). That is, the reception device 300 may determine whether the input password and the password 142 are the same after performing the wake-up, and when the input password and the password 142 are the same, perform the function setting operation.

In operation S725, when the password length 141 is zero, the reception device 300 may perform operation S727. That is, the reception device 300 may proceed to perform the function setting operation after performing the wake-up.

In FIG. 15, an example in which the password 142 of the wake-up packet 100 is the password for performing the function setting operation is illustrated, but the password 142 may be the password for performing the wake-up. In this case, for example, operations S725 and S726 may be performed between operations S721 and S722, or between operations S722 and S723.

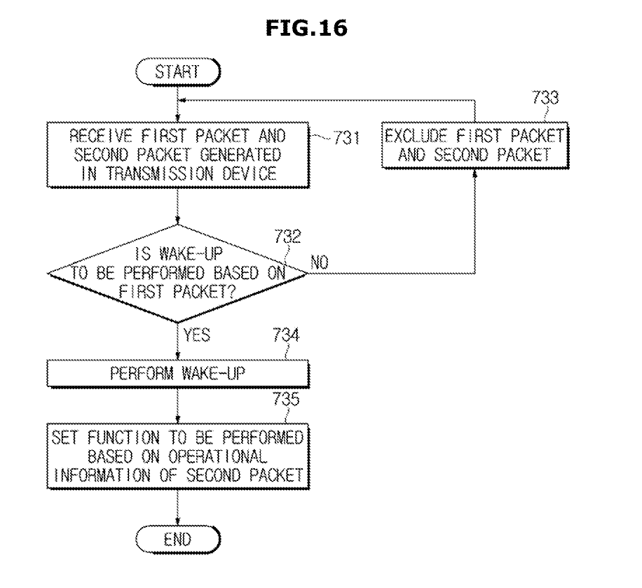

FIG. 16 is a flowchart for describing a wake-up method in accordance with still another exemplary embodiment.

Referring to FIG. 16, first, the reception device 300 may receive the wake-up packet 100 generated in the transmission device 200 (S731). At this time, the wake-up packet 100 may include the first packet 101 and the second packet 102 as shown in FIGS. 11A and 11B. The reception device 300 may sequentially receive the first packet 101 and the second packet 102 which are sequentially transmitted from the transmission device 200.

The reception device 300 may determine whether to perform the wake-up packet 100 based on the first packet 101 (S732). Particularly, the reception device 300 may exclude the header of the first packet 101, obtain the wake-up information 120 from the first packet 101, and determine whether to perform the wake-up based on the obtained wake-up information 120.

Particularly, the reception device 300 may obtain a repeated MAC address from the wake-up information 120, and determine whether to perform the wake-up based on whether the MAC address obtained from the wake-up information 120 is identical to its own MAC address. That is, the reception device 300 may determine to perform the wake-up when the MAC address obtained from the wake-up information 120 is identical to its own MAC address, and determine to maintain the sleep mode when the MAC address obtained from the wake-up information 120 is not identical to its own MAC address.

When it is determined that the wake-up is not to be performed (“no” to operation (S732), the reception device 300 may exclude the first packet 101 and the second packet 102 (S733) and maintain the sleep mode.

When it is determined that the wake-up is to be performed (“yes” to operation S732), the reception device 300 may perform the wake-up according to the wake-up ID 121 (S734). That is, the reception device 300 may be turned on and waken up from the sleep mode.

After performing the wake-up, the reception device 300 may perform the operation of setting a function to be performed based on the operational information 130 of the second packet 102 (S735).

According to the transmission device and the reception device for transmission and reception of the wake-up packet, the wake-up system and the wake-up method according to the exemplary embodiments, the transmission device may transmit the wake-up packet including not only the wake-up information but also the operational information. Further, the reception device can receive the wake-up packet, and perform the operation for setting the function to be performed after the wake-up. The setting of the function to be performed after the wake-up can be performed by transmitting and receiving the wake-up packet. Accordingly, user convenience may be improved.

Although a few exemplary embodiments are shown and described with reference to the accompanying drawings, it would be appreciated by those skilled in the art that changes may be made in these embodiments without departing from the principles and spirit of the disclosure, the scope of which is defined in the claims and their equivalents.

What is claimed is:

1. A transmission apparatus comprising:
a controller configured to generate a wake-up packet comprising wake-up information for waking up a reception apparatus and operational information for setting a function to be performed by the reception apparatus in response to a wake-up of the reception apparatus; and
a communicator configured to perform communication with the reception apparatus to transmit the wake-up packet to the reception apparatus.

2. The transmission apparatus of claim 1, wherein the reception apparatus comprises a plurality of reception apparatuses.

3. The transmission apparatus of claim 1, wherein the wake-up packet comprises a header, the wake-up information, and the operational information.

4. The transmission apparatus of claim 1, wherein the wake-up information comprises a wake-up identification (ID) and a wake-up address.

5. The transmission apparatus of claim 4, wherein the wake-up ID comprises a control command for performing the wake-up of the reception apparatus.

6. The transmission apparatus of claim 5, wherein the wake-up ID is provided using at least one from among a wake on local area network (WOL) and a wake on wireless local area network (WoWLAN).

7. The transmission apparatus of claim 5, wherein the wake-up address comprises ID information of the reception apparatus, which is selected to perform the wake-up among a plurality of reception apparatuses.

8. The transmission apparatus of claim 7, wherein the wake-up address comprises a media access control (MAC) address of the reception apparatus.

9. The transmission apparatus of claim 7, wherein the operational information comprises a control command for setting the function to be performed by the reception apparatus in response to the wake-up of the reception apparatus.

10. The transmission apparatus of claim 7, wherein the operational information comprises an operation code corresponding to the function to be performed by the reception apparatus in response to the wake-up of the reception apparatus.

11. The transmission apparatus of claim 1, wherein the wake-up packet further comprises password information, the password information comprising at least one from among a password for waking up the reception apparatus and a password for setting the function.

12. The transmission apparatus of claim 1, wherein the wake-up packet comprises a first packet comprising the wake-up information, and a second packet comprising the operational information.

13. The transmission apparatus of claim 12, wherein the communicator is configured to sequentially transmit the first packet and the second packet.

14. A reception apparatus comprising:
a communicator configured to perform communication with a transmission apparatus to receive, from the transmission apparatus, a wake-up packet comprising wake-up information for waking up the reception apparatus and operational information for setting a function to be performed by the reception apparatus in response to a wake-up of the reception apparatus; and
a controller configured to control to perform the wake-up of the reception apparatus based on the wake-up information and set the function to be performed in response to the wake-up of the reception apparatus based on the operational information.

15. The reception apparatus of claim 14, wherein the communicator is configured to sequentially receive a first packet comprising the wake-up information and a second packet comprising the operational information.

16. A wake-up system comprising:
a transmission apparatus configured to transmit a data packet; and
a reception apparatus configured to receive the data packet,
wherein the transmission apparatus is configured to generate a wake-up packet, the wake-up packet comprising wake-up information for waking up the reception apparatus and operational information for setting a function to be performed by the reception apparatus in response to a wake-up of the reception apparatus, and transmit the wake-up packet to the reception apparatus, and
the reception apparatus is configured to receive the wake-up packet from the transmission apparatus, perform the wake-up of the reception apparatus based on the wake-up information, and set the function to be performed after the wake-up based on the operational information.

17. A wake-up method comprising:
receiving, by a reception apparatus, a data packet from a transmission apparatus;
determining, by the reception apparatus, whether the received data packet is a wake-up packet comprising wake-up information for waking up the reception apparatus and operational information for setting a function to be performed by the reception apparatus in response to a wake-up of the reception apparatus; and
performing, by the reception apparatus, the wake-up based on the wake-up information in response to determining that the received packet is the wake-up packet and setting the function to be performed after the wake-up based on the operational information.

18. The wake-up method of claim 17, wherein the wake-up information comprises a wake-up ID and a wake-up address.

19. The wake-up method of claim 18, wherein the determining comprises determining whether the wake-up ID is included in the received data packet.

20. The wake-up method of claim 18, wherein the wake-up address comprises ID information of the reception apparatus that is selected to perform the wake-up.

21. The wake-up method of claim 20, wherein the performing comprises determining whether ID information of the reception apparatus is identical to the ID information of the wake-up address and performing the wake-up when the ID information of the reception apparatus is identical to the ID information of the wake-up.

22. The wake-up method of claim 17, wherein the wake-up packet further comprises password information, the password comprising at least one from among a password for the wake-up and a password for setting the function.

23. The wake-up method of claim 22, further comprising:
determining whether an input password is identical to the password included in the password information.

24. The wake-up method of claim 17, wherein the receiving comprises sequentially receiving a first packet comprising the wake-up information and a second packet comprising the operational information.

25. A reception apparatus comprising:
at least one memory operable to store program code;
at least one processor operable to read the program code and operate as instructed by the program code, the program code including:
wake-up code configured to cause the at least one processor to perform a wake-up of the reception apparatus from a standby mode in response to receiving a wake-up packet, wherein the wake-up packet comprises information about a function to be performed in response to the wake-up of the reception apparatus; and
function setting code configured to cause the at least one processor to perform the function in response to the wake-up of the reception apparatus.
